(19) United States
(12) Patent Application Publication
(10) Pub. No.: US 2005/0071999 A1
(43) Pub. Date: Apr. 7, 2005

(54) Method of producing a turbine rotor having a control wheel

(76) Inventors: Herbert Bartsch, Dogern (DE); Dieter Freuschle, Waldshut-Tiengen (DE)

Correspondence Address: CERMAK & KENEALY LLP, P.O. BOX 7518, ALEXANDRIA, VA, 22307, US

(21) Appl. No.: 10/932,263

(22) Filed: Sep. 2, 2004

(30) Foreign Application Priority Data
Sep. 2, 2003 (EP) 03103266.7

(51) Int. Cl. B23K 1/00; B63H 1/16

(52) U.S. Cl. 29/889.23; 228/101; 29/889.2

(57) ABSTRACT

A method of producing a rotor (1), equipped with a control wheel (4), of a turbine, in particular a steam turbine, includes the following steps:
A: producing a closed blade ring (5),
B: separating the blade ring (5) into a plurality of parts (11, 12),
C: assembling the parts (11, 12) around the rotor (1) in such a way that the assembled blade ring (5) encloses the rotor (1), and
D: welding the assembled blade ring (5) to the rotor (1) at an axial section (10) intended for the control wheel (4).

This application claims priority under 35 U.S.C. § 119 to European application number 031 032 66.7, filed 02 Sep. 2003, the entirety of which is incorporated by reference herein.

### BACKGROUND OF THE INVENTION

1. Field of the Invention

The invention relates to a method of producing a rotor, equipped with a control wheel, of a turbine, in particular a steam turbine.

2. Brief Description of the Related Art

In a nozzle-controlled steam turbine, the first impeller in the direction of the steam flow is normally referred to as the “control wheel”. This control wheel is subjected to very high stress by the prevailing high temperatures and by the admission of steam during operation of the steam turbine. In order to attach a control wheel to the turbine or to a rotor of the turbine in such a way that it withstands these high stresses, the control wheel is normally produced in the form of a closed blade ring which is completely welded to that point on the rotor which is provided for it. However, this conventional procedure for producing a rotor equipped with a control wheel is only possible when the inside diameter of the blade ring is larger than the outside diameter of the rotor upstream of or downstream of the point intended for the control wheel. Problematical in this case are in particular the cross sections in the piston region, in the coupling region and in the blading region. For the situation where the piston diameter is to be larger than the inside diameter of the blade ring, it is normal practice with a conventional procedure to provide the piston with a smaller outside diameter to begin with, so that the closed blade ring can be pushed over the piston region in order to weld the blade ring to the rotor downstream of the piston in order to form the control wheel in this way. The piston diameter must then be increased to the desired size by build-up welding. This procedure is very expensive and is only appropriate in the case of relatively small differences in diameter. These problems may occur during the production in the course of initial mounting, in particular when the rotor is a monoblock rotor. However, the problems described may also occur during production in the course of subsequent mounting, e.g. during the exchange or replacement of a control wheel.

### SUMMARY OF THE INVENTION

The invention is intended to provide a remedy here. The present invention deals with the problem of specifying a method of the aforementioned type which makes it possible to attach a closed control wheel to the rotor of a turbine even if the rotor, upstream of and downstream of the control wheel, has an outside diameter which is larger than the inside diameter of the blade ring which forms the control wheel.

The invention is based on the general idea of first of all producing a closed blade ring, separating it into a plurality of parts, that is to say at least two parts, and assembling it again on the rotor. Due to this procedure, the ease with which the blade ring can be mounted is essentially unaffected by the rotor diameters appearing upstream of and downstream of the control wheel. In this case, the high stressability of the separately produced closed blade ring is retained, since the individual parts of the blade ring, when being mounted on the rotor, can be joined together again to form the closed blade ring. The method according to the invention can be carried out both in the case of initial new production and in the case of subsequent reconstruction of a turbine rotor equipped with a control wheel.

The assembly of the parts of the blade ring around the rotor can be simplified in a preferred embodiment by this being carried out in an axial section of the rotor, the outside diameter of this axial section being smaller than the inside diameter of the blade ring. In particular, it is thereby possible in a relative simple manner to join together or reconstruct the closed blade ring from the individual parts before it is positioned on the rotor at the point intended for the control wheel.

Accordingly, in an advantageous development, the assembled parts can be welded to one another at their points of separation, the assembled blade ring only then being welded to the rotor. The high-strength closed blade ring which can be subjected to high loading is therefore completely reconstructed before it is welded to the rotor at the position intended for it. The high stability of the closed blade ring under load with increased safety can be ensured by this procedure.

A development of the method is preferred in which the parts for the assembly are inserted into an auxiliary mounting ring, the internal diameter of which corresponds to the external diameter of the blade ring. The positioning of the individual parts relative to one another is simplified by this measure.

In a development, the insertion and assembly of the parts in the auxiliary mounting ring can be effected in an axial section of the rotor, the outside diameter of this axial section being smaller than the inside diameter of the blade ring, the assembled parts being welded to one another on the insides of their points of separation before the welded-together blade ring is welded to the rotor. With this procedure, the auxiliary mounting ring facilitates positioning and thereby makes it easier to connect the individual parts for reconstructing the closed blade ring.

According to a development, after the welding of the parts on the insides of the points of separation and before the welding of the blade ring to the rotor, the auxiliary mounting ring can be removed in order to be able to also weld the parts to one another on the outsides of their points of separation. The high strength of the closed blade ring can be ensured by this measure even before the blade ring is welded to the rotor.

The welding of the assembled and possibly reconstructed blade ring to the rotor can be improved by the assembled blade ring, for the welding to the rotor, being positioned with an auxiliary mounting ring which coaxially encloses the blade ring and whose inside diameter corresponds to the outside diameter of the blade ring. This measures permits exact positioning of the blade ring on the one hand and prevents deformations of the blade ring on account of the welding operation on the other hand.

Further important features and advantages of the method according to the invention follow from the drawings and from the associated description of the figures with reference to the drawings.

### BRIEF DESCRIPTION OF THE DRAWINGS

A preferred exemplary embodiment of the invention is shown in the drawings and is described in more detail below. In the drawing, in each case schematically:

FIG. 1 shows a longitudinal section through a rotor equipped with a control wheel, and

FIG. 2 shows a cross section through the rotor along section line II-II in FIG. 1 during the implementation of the method according to the invention.

### DETAILED DESCRIPTION OF THE PREFERRED EMBODIMENTS

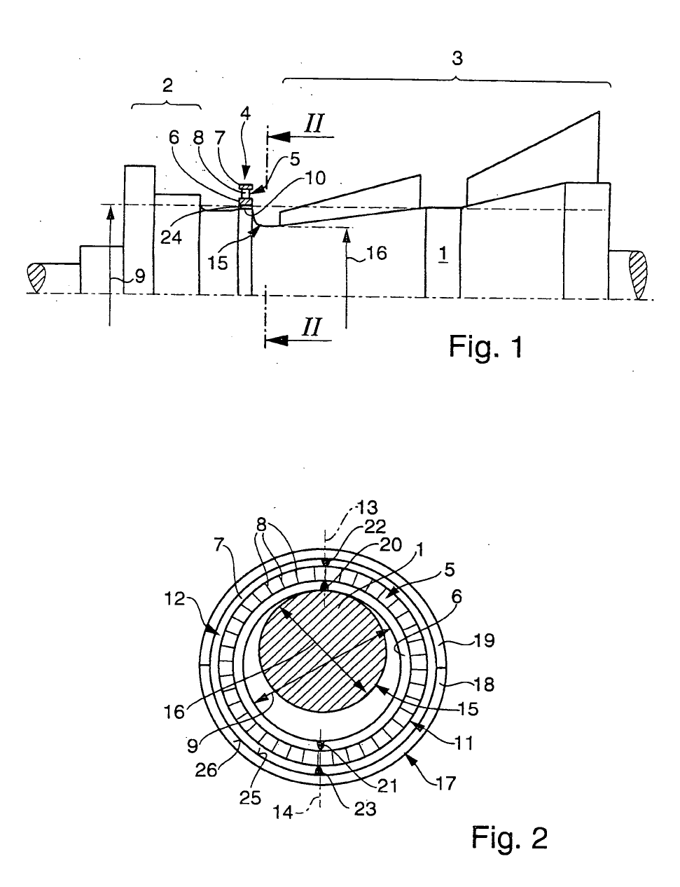

According to FIG. 1, a rotor 1 of a turbine (otherwise not shown), in particular of a steam turbine, has an axial piston region 2, which is identified here by a brace, and an axial blade region 3, which is likewise identified here by a brace. Arranged axially between the piston region 2 and the blade region 3 is a control wheel 4, which forms the first moving blade of the turbine. The turbine is preferably designed as a nozzle-controlled steam turbine.

In order to obtain a control wheel 4 having especially high strength and stressability, it is produced from a closed blade ring 5 which comprises a root 6 closed in a ring shape, a shroud band 7 closed in a ring shape and blades 8 extending radially between root 6 and shroud band 7. Both the piston region 2 preceding upstream and the blade region 3 following downstream have outside diameters which are greater than an inside diameter of the blade ring 5. On account of these predetermined design conditions, the closed blade ring 5 cannot be pushed in the axial direction either over the piston region 2 or over the blade region 3 onto an axial section or seat 10 intended for the control wheel 4.

In order to equip a turbine or its rotor 1 with such a closed control wheel 4, the procedure according to the invention is as follows:

First of all the closed blade ring 5 is produced. This may be done in a conventional manner. For example, the blade ring 5 is welded together from individual blades and tempered. Likewise, a forged ring can be formed into the blade ring 5 by milling, electrical discharge machining or the like.

In a next production step, the closed blade ring 5 is separated into a plurality of parts, here into two parts 11 and 12 (cf. FIG. 2). This separation into two parts or halves 11, 12 may be carried out, for example, by means of wire electrical discharge machining or by means of a laser separation process or with other suitable separation processes. Points of separation 13 and 14, which are symbolically shown by dot-dash lines, are produced in this case. It is clear that the blade ring 5 can be split into more than two parts 11, 12.

The points of separation 13 and 14 can then be prepared, e.g. by cleaning and deburring them, for the production of welds.

In a subsequent step, the parts 11, 12 are assembled around the rotor 1, the assembled blade ring 5 enclosing the rotor 1. The assembly is effected here in an axial section 15 of the rotor 1, the outside diameter 16 of this axial section 15 being smaller than the inside diameter 9 of the blade ring 5. Furthermore, an auxiliary mounting ring 17, into which the individual parts 11 and 12 are inserted, is used here for the assembly of the parts 11 and 12. This auxiliary mounting ring 17 has an inside diameter 25 which is the same size as an outside diameter 26 of the blade ring 5. This results in optimum positioning of the individual parts 11, 12 relative to one another. Here, the auxiliary mounting ring 17 likewise consists of two parts 18 and 19, which can be fastened to one another by releasable fastening means (not shown here) in order to form the completely closed auxiliary mounting ring 17.

The halves or parts 11 and 12 of the blade ring 5 are positioned by the auxiliary mounting ring 17 and can be welded to one another on the insides of their points of separation 13 and 14. The inner welds 20 and 21 are formed in the process. The halves 11 and 12 are therefore welded to one another in the region of the root 6 by the inner welds 20, 21. The inner welds 20, 21 can then be trimmed and tested.

Then, in a preferred variant, the auxiliary mounting ring 17 is removed. The halves 11, 12 can then also be welded to one another on the outsides of their points of separation 13 and 14, in the course of which the outer welds 22 and 23 are formed. The parts 11 and 12 are therefore welded to one another in the region of the shroud band 7 by the outer welds 22 and 23. The outer welds 22 and 23 can then also be trimmed and tested. The blade ring 5 separated beforehand is now again joined together to form a complete closed blade ring 5.

In a next step, the auxiliary mounting ring 17 is again placed around the reconstructed blade ring 5 in order thus to push the blade ring 5 in the axial direction onto the seat 10 provided for it on the rotor 1. In this case, the auxiliary mounting ring 17 permits the optimum positioning of the blade ring 5 and gives the latter the requisite dimensional stability for the subsequent welding operations. The set, optimum position of the blade ring 5 relative to the rotor 1 can be fixed by means of a fixing weld. It is then possible to form a main weld 24, with which the blade ring 5 is welded to the rotor 1. The welded connection can subsequently be heat-treated, for example by stress-free annealing.

Finally, the outer edge of the now formed control wheel 5 can be completed, in particular by turning. Final inspection of the welds 20 to 24 can ensure their quality.

A rotor 1 which is equipped with a closed control wheel 4 can therefore be produced by the method according to the invention. In this case, the outside diameters in the regions 2 and 3 upstream of and downstream of the control wheel 4 are not important, so that, in particular, new production in a monoblock rotor and reconstruction, e.g. in the event of a service, in a conventional rotor are possible.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

1. A method of producing a rotor, equipped with a control wheel, of a turbine, comprising:
(A) producing a closed blade ring;
(B) separating the blade ring into a plurality of parts;
(C) assembling the plurality of parts around the rotor in such a way that the assembled blade ring encloses the rotor; and
(D) welding the assembled blade ring to the rotor at an axial section intended for the control wheel.

2. The method as claimed in claim 1, wherein step C assembling is carried out in an axial section of the rotor, the outside diameter of which axial section is smaller than the inside diameter of the blade ring.

3. The method as claimed in claim 1, comprising:
welding the assembled parts to one another at their points of separation; and thereafter
welding the assembled blade ring to the rotor according to step D.

4. The method as claimed in claim 1, comprising:
inserting the plurality of parts for said assembling according to step C into an auxiliary mounting ring having an internal cross section which corresponds to the external cross section of the blade ring.

5. The method as claimed in claim 4, wherein said inserting and said assembling of the plurality of parts in the auxiliary mounting ring is effected in an axial section of the rotor, wherein the outside diameter of said axial section is smaller than the inside diameter of the blade ring; and comprising
welding the assembled parts to one another on the insides of their points of separation before step D.

6. The method as claimed in claim 5, comprising, after said welding of the plurality of parts on the insides of the points of separation and before step D:
removing the auxiliary mounting ring and welding the plurality of parts to one another on the outsides of their points of separation.

7. The method as claimed in claim 1, comprising:
positioning the assembled blade ring, for the welding to the rotor according to step D, with an auxiliary mounting ring which coaxially encloses the blade ring and an inside diameter of which auxiliary mounting ring corresponds to the outside diameter of the blade ring.

8. A method according to claim 1, wherein the turbine comprises a steam turbine.
